(19) United States
(12) Patent Application Publication
(10) Pub. No.: US 2026/0220411 A1
(43) Pub. Date: Jul. 30, 2026

(54) COLOR ADJUSTMENT MANAGEMENT METHOD, COLOR ADJUSTMENT MANAGEMENT APPARATUS, AND STORAGE MEDIUM

(71) Applicant: Konica Minolta, Inc., Tokyo (JP)

(72) Inventor: Kouichirou MATSUSHITA, Tokyo (JP)

(21) Appl. No.: 19/459,654

(22) Filed: Jan. 26, 2026

(30) Foreign Application Priority Data
Jan. 27, 2025 (JP) 2025-011267

(51) Int. Cl. G06K 15/02

(52) U.S. Cl. CPC G06K 15/1878; G06K 15/027; G06K 15/1882; G06K 2215/0094

(57) ABSTRACT

A color adjustment management method is to be performed by a color adjustment management apparatus that manages multiple types of color adjustment for an image forming apparatus. The method includes: presenting a first operation screen for individually designating the multiple types of color adjustment; and presenting a second operation screen for designating a routine including at least two types of color adjustment among the multiple types of color adjustment.

### CROSS-REFERENCE TO RELATED APPLICATIONS

The entire disclosure of Japanese Patent Application No. 2025-011267 filed on Jan. 27, 2025, is incorporated herein by reference in its entirety.

### BACKGROUND OF THE INVENTION

### Technical Field

The present disclosure relates to a color adjustment management method, a color adjustment management apparatus, and a storage medium.

### Description of Related Art

A printing system for commercial printing has a plurality of types of color adjustment functions. Such a printing system requires color adjustment by a user having expertise. The user needs to perform color adjustment by combining necessary functions depending on the state of the printer. It is difficult for a user without expertise to fully utilize the color adjustment function.

There has been proposed a system in which an administrator who performs color management of multiple printing machines creates a color profile, based on output characteristic information of each printing machine, and sends the created color profile and other color adjustment information to each printing machine (see Japanese Unexamined Patent Application Publication No. 2009-37405). Thus, the colors of printing machines can be matched without forcing normal users to perform complicated operations.

### SUMMARY OF THE INVENTION

In the above prior art, the information provided to each printing machine is mainly settings on the output related to the color profile. The above prior art cannot cope with accurate color adjustment that meet needs of users, such as readjustment for deterioration in color quality due to temporal/environmental changes and color matching with a spot color or a color sample.

It is still difficult for a general user to determine (i) which color adjustment function(s) should be used among multiple color adjustment functions, (ii) in what order the color adjustment function(s) should be performed, and (iii) when the color adjustment should be ended, in order to reproduce desired colors.

The present disclosure has been made in view of the above-described challenge in the related art. An object of the present disclosure is to allow a user who does not have expertise to perform color adjustment including a combination of multiple types of color adjustment.

To achieve at least one of the abovementioned objects, according to an aspect of the present invention, there is provided a color adjustment management method to be performed by a color adjustment management apparatus that manages multiple types of color adjustment for an image forming apparatus, the method including: presenting a first operation screen for individually designating the multiple types of color adjustment; and presenting a second operation screen for designating a routine including at least two types of color adjustment among the multiple types of color adjustment.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a configuration diagram of a color management system in an embodiment of the present disclosure;

FIG. 2 is a block diagram illustrating a configuration of a printer;

FIG. 3 is a block diagram illustrating the configuration of a PC;

FIG. 4 illustrates an example of a data configuration of a rule setting table;

FIG. 5 is an example of a colorimetry chart for in-plane unevenness adjustment;

FIG. 6 is an example of a colorimetry chart for maximum density adjustment;

FIG. 7 is an example of a colorimetry chart for single-color tone adjustment;

FIG. 8 is an example of a colorimetry chart for mixed-color tone adjustment;

FIG. 9 is an example of a tone curve adjustment screen;

FIG. 10 is an example of an adjustment screen in “adjustment of specified color conversion based on comparison of candidate colors” or “spot color adjustment based on comparison of candidate colors”;

FIG. 11 is an example of the adjustment screen in “adjustment of specified color conversion by manual input” or “spot color adjustment by manual input”;

FIG. 12 is a flowchart of overall processing;

FIG. 13 is a flowchart of overall processing;

FIG. 14 is an example of a first operation screen;

FIG. 15 is an example of a second operation screen;

FIG. 16 is a flowchart of a first routine process;

FIG. 17 is a flowchart of a second routine process;

FIG. 18 is a flowchart of a third routine process; and

FIG. 19 is a flowchart of a fourth routine process.

### DETAILED DESCRIPTION

In the following, an embodiment of the present disclosure will be described with reference to the drawings. The advantages and features provided by the embodiment will be understood from the following detailed description and the drawings. However, the scope of the present disclosure is not limited to the embodiment disclosed below or the drawings.

### Configuration of Color Management System

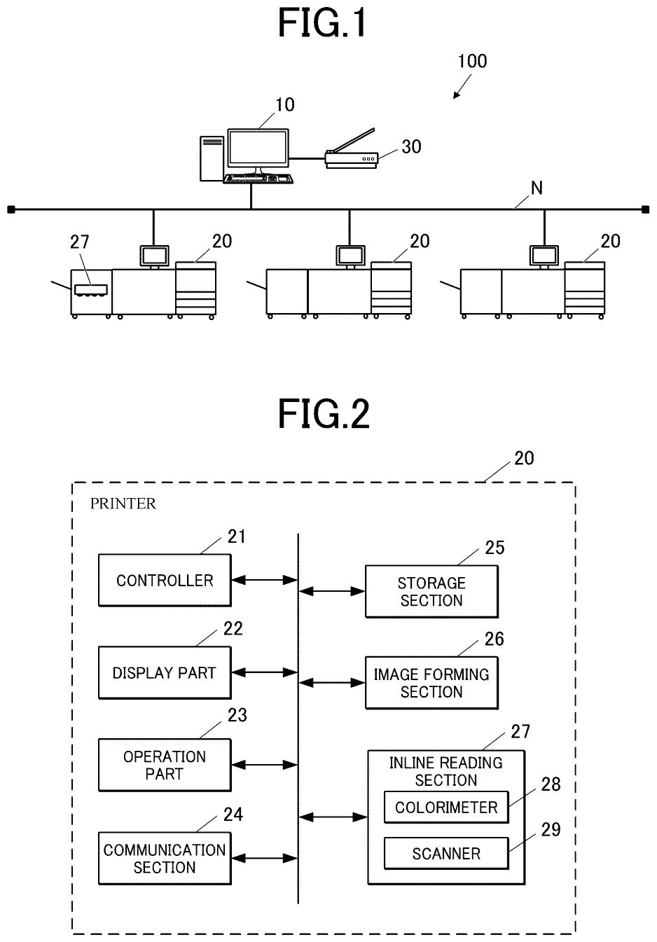

FIG. 1 illustrates a configuration of a color management system 100 according to an embodiment. The color management system 100 includes a personal computer (PC) 10 as a color adjustment management apparatus and printers 20. The PC 10 and each of the printers 20 are connected over a communication network N, such as a local area network (LAN), to perform data communication.

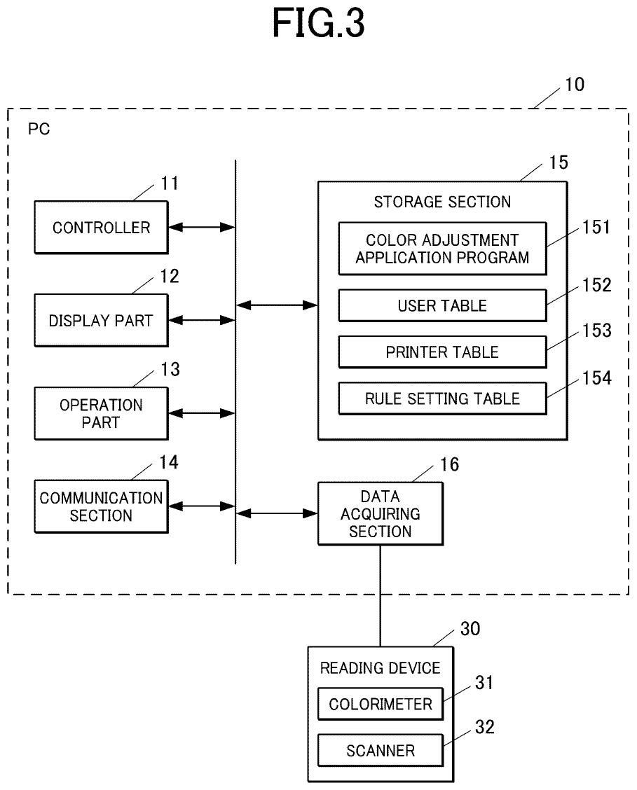

The PC 10 instructs the printers 20 to output print jobs and performs color adjustment of the printers 20. A color adjustment application program 151 (see FIG. 3) for performing color adjustment is installed in the PC 10.

The printer 20 is an image forming apparatus that forms an image on a sheet. Each of the printers 20 can form an image with color material of cyan (C), magenta (M), yellow (Y), and black (K).

In the color adjustment, it is necessary to measure colors. Therefore, the printer 20 includes an inline reading section 27, or a reading device 30 is connected to the PC 10.

FIG. 2 shows a configuration of the printer 20. The printer 20 includes a controller 21, a display part 22, an operation part 23, a communication section 24, a storage section 25, and an image forming section 26.

The controller 21 centrally controls processing operations of the components of the printer 20. The controller 21 includes a central processing unit (CPU) and a random access memory (RAM). Specifically, the CPU reads various programs stored in the storage section 25 and loads the program in the RAM. The CPU performs various kinds of processing according to the program.

The display part 22 consists of a liquid crystal display (LCD). The display part 22 displays various screens in accordance with instructions of display signals input by the controller 21.

The operation part 23 receives various operations by a user and outputs an operation signal based on the operation to the controller 21.

The communication section 24 consists of a network interface or the like. The communication section 24 sends and receives data to and from external devices connected over the communication network N. For example, the communication section 24 receives a print instruction or the like from an external device, such as the PC 10.

The storage section 25 includes a hard disk drive (HDD), a solid-state drive (SSD), and a non-volatile memory. The storage section 25 stores various processing programs and various kinds of data, such as parameters and files necessary for executing the programs. For example, the storage section 25 stores sheet information on the printer 20, adjustment values for color adjustment, a color conversion table, and tone curves, for example.

The image forming section 26 forms an image on a sheet by the electrophotographic method. The image forming section 26 includes photosensitive drums corresponding to the respective colors (cyan, magenta, yellow, and black) of toner to be used for image formation, an intermediate transfer belt, and a fixing section. For example, the image forming section 26 uniformly charges a photosensitive drum corresponding to cyan and scans and exposes the photosensitive drum with a laser beam, based on image data to form an electrostatic latent image. The image forming section 26 develops the electrostatic latent image on the photosensitive drum corresponding to cyan by causing cyan toner to adhere to the electrostatic latent image. Processing for the other colors is the same as for cyan. The image forming section 26 sequentially transfers the toner images of respective colors formed on the photosensitive drums corresponding to the respective colors onto the intermediate transfer belt (primary transfer). That is, a toner image in which toner images of multiple colors are superimposed is formed on the intermediate transfer belt. The image forming section 26 transfers the color toner image on the intermediate transfer belt onto a sheet (secondary transfer). The image forming section 26 causes the fixing section to fix the color toner image onto the sheet. The controller 21 causes the image forming section 26 to form an image, based on the image data.

The printers 20 may include an inline reading section 27. The inline reading section 27 is provided on a conveyance route of the sheet after image formation. The inline reading section 27 reads the conveyed sheet. The inline reading section 27 includes a colorimeter 28 and a scanner 29.

The colorimeter 28 is a spectrophotometer and outputs colorimetric values (e.g., L*a*b* values, XYZ values). Although the colorimeter 28 in the present embodiment outputs L*a*b* values, the present invention is not limited to this. For example, the colorimeter 28 is configured to be movable in a sheet width direction perpendicular to the sheet conveyance direction. By moving in the sheet width direction with respect to the conveyance sheet, the colorimeter 28 can perform colorimetry on the colors of the entire area on the sheet. The colorimeter 28 may be used for calibration of the scanner 29.

The scanner 29 is capable of reading the entire sheet in a direction perpendicular to the sheet conveyance direction. The scanner 29 reads the conveyed sheet and generates read image data having pixel values of the respective colors of red (R), green (G), and blue (B). The scanner 29 is, for example, a linear CCD sensor.

If the printer 20 includes the inline reading section 27, the controller 21 sends colorimetric values (L*a*b* values) of the target color measured by the colorimeter 28 to the PC 10. The controller 21 converts the read image data (RGB values) generated by the scanner 29 scanning the sheet into colorimetric values (L*a*b* values) using the scanner profile of the scanner 29 and sends the read image data in the colorimetric values to the PC 10.

FIG. 3 shows a configuration of the PC 10. The PC 10 includes a controller 11, a display part 12, an operation part 13, a communication section 14, a storage section 15, and a data acquiring section 16.

The controller 11 centrally controls processing operation of each part of the PC 10. The controller 11 includes a CPU and a RAM. Specifically, the CPU reads various processing programs stored in the storage section 15 and loads the programs in the RAM. The CPU performs various kinds of processing according to the program.

The display part 12 includes a monitor, such as an LCD. The display part 12 displays various screens according to instructions of display signals input by the controller 11.

The operation part 13 includes a keyboard and a pointing device such as a mouse. The operation part 13 outputs, to the controller 11, a signal based on a key operation on the keyboard and an operation on the pointing device.

The communication section 14 consists of a network interface, for example. The communication section 14 sends and receives data to and from an external device, such as the printer 20 connected over the network N.

The storage section 15 includes an HDD, an SSD, and a nonvolatile memory. The storage section 15 stores various processing programs and various kinds of data, such as parameters and files necessary for executing the programs. For example, the storage section 15 stores a color adjustment application program 151. A color adjustment application is implemented by the cooperation of the controller 11 and the color adjustment application program 151. The color adjustment application provides a user interface for giving instructions to execute color adjustment functions of the printer 20, checking color measurement results, and calculating adjustment values, for example. The color adjustment application can be connected to the printers 20 over the communication network N and the external reading device 30. The color adjustment application acquires adjustment values held in the printer 20 or sets adjustment values to the printer 20. The storage section 15 stores data, such as a chart to be used for color adjustment.

The storage section 15 also stores a user table 152, a printer table 153, and a rule setting table 154.

The user table 152 is a table for managing user information on users who can use the PC 10 (color adjustment management apparatus). In the user table 152, each user is associated with his/her username, password, attribute, and so forth.

The username is identification information of a user.

The password is a password set for the user. The username and the password are used for user authentication when the users log in to the PC 10.

The attribute is information indicating the attribute of the user. In the present embodiment, the attribute is either “administrator” or “general user”. The administrator has expertise in color adjustment of the printer 20 and is an expert in color adjustment. The general user is an operator (beginner) who does not have expertise on color adjustment of the printer 20 and is inexperienced in color adjustment.

The printer table 153 is a table for managing printer information on the printers 20 in the color management system 100. In the printer table 153, each printer 20 is associated with its printer name, IP address, sheet information, whether the printer 20 has an inline reading section, and so forth.

The printer name is the name of the printer 20.

The IP address is the IP address of the printer 20.

The sheet information is information on sheets to be used by the printer 20. The sheet information includes a sheet size, a sheet type, a basis weight, a sheet color, and the like.

Whether the printer 20 has an inline reading section is information indicating whether the printer 20 has the inline reading section 27.

The rule setting table 154 is a table that shows rules having been set for each routine for the general users. The routine indicates a procedure including a combination of at least two types of color adjustment among multiple types of color adjustment. Depending on the result of the color adjustment in the routine, the color adjustment to be performed next can be dynamically changed.

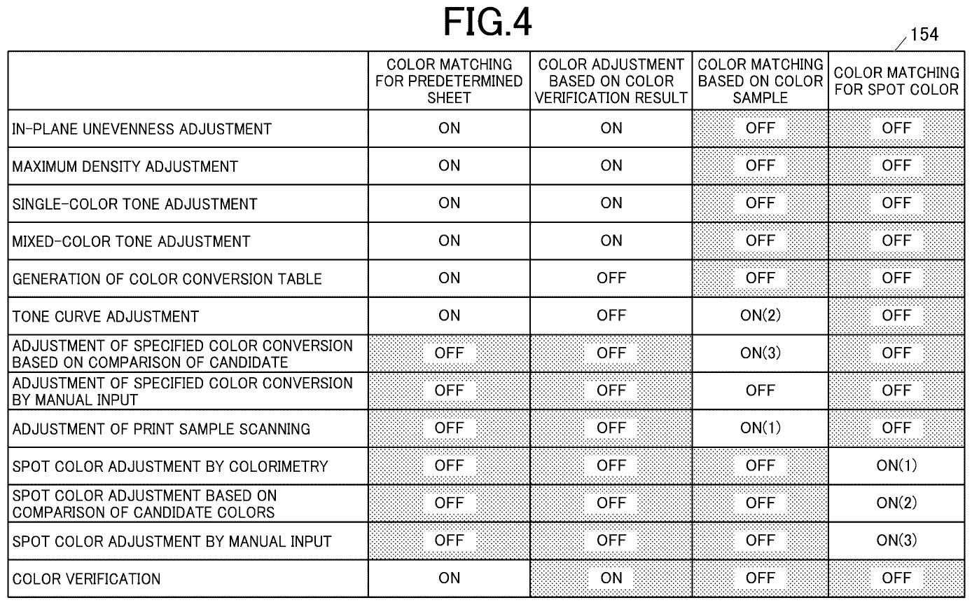

FIG. 4 illustrates an example of a data configuration of the rule setting table 154. In the rule setting table 154, the routines corresponding to the respective purposes of color adjustment are associated with whether the color adjustment items are included (ON/OFF) in the routines. In the example of FIG. 4, the purposes of color adjustment are “color matching for predetermined sheet”, “color adjustment based on color verification result”, “color matching based on color sample”, and “color matching for spot color”. Whether the routine corresponding to a purpose of color adjustment includes each color adjustment item can be changed by rule settings.

The color adjustment items that need not be adjusted in each color adjustment purpose are fixed to “OFF” and cannot be changed to “ON”. Further, the color adjustment items that need to be adjusted in each color adjustment purpose are fixed to “ON” and cannot be changed to “OFF”. In the rule setting table 154 of FIG. 4, the unchangeable color adjustment items are indicated by a shaded background pattern.

For the color adjustment purposes of “color matching based on color sample” and “color matching for spot color”, the execution order of color adjustment items in the routine can be changed. In the rule setting table 154 of FIG. 4, the numbers in parentheses after “ON” indicate the execution order of the color adjustment items in the routine.

In the rule setting table 154, particular color adjustment items are not performed (set to “OFF”) in the routine corresponding to each color adjustment purpose owing to the following reasons.
(1) It takes time to perform color adjustment.
(2) A color adjustment item that requires skills does not influence significantly no matter whether a general user performs the item. In a case where such color adjustment items are necessary, it is desirable that an administrator (a skilled person) performs the color adjustment item.

The data acquiring section 16 acquires data generated by the reading device 30.

The reading device 30 is connected to the PC 10 via a universal serial bus (USB) cable, for example. The reading device 30 measures the colors of a patch group included in a chart printed by the printer 20 and outputs colorimetric values. The reading device 30 reads a color sample. The reading device 30 includes a colorimeter 31 and a scanner 32.

The colorimeter 31 is a spectrophotometer and outputs colorimetric values (e.g., L*a*b* values, XYZ values). Although the colorimeter 31 in the present embodiment outputs L*a*b* values, the present invention is not limited to this.

The scanner 32 is a flatbed scanner and reads the entire sheet having been set. The scanner 32 reads a sheet and generates read image data having pixel values of the respective colors of red (R), green (G), and blue (B).

The reading device 30 outputs colorimetric values (L*a*b* values) obtained by the colorimeter 31 measuring the target colors to the PC 10. The reading device 30 converts the read image data (RGB values) generated by the scanner 32 scanning the sheet into colorimetric values (L*a*b* values) using the scanner profile of the scanner 32 and sends the read image data in the colorimetric values to the PC 10.

In cooperation with the color adjustment application program 151, the controller 11 manages multiple types of color adjustment (color management items) for each printer 20 connected over the communication network N. For example, the controller 11 performs color adjustment for the target printer 20.

The controller 11 presents a first operation screen for an administrator to specify individual types of color adjustment.

The controller 11 presents a second operation screen (for general users) for specifying a routine including at least two color adjustment items among multiple color adjustment items. Depending on the processing result in the middle of the routine, the subsequent procedure of the routine may be changed.

The PC 10 as the color adjustment management apparatus is available to multiple users.

The controller 11 controls presentation of the first operation screen and the second operation screen according to the user who uses the PC 10 (color adjustment management apparatus).

The controller 11 allows a first user among multiple users to perform operation on the first operation screen. The controller 11 allows the first user to perform operation on the first operation screen on the PC 10 used by the first user. In the present embodiment, the first user is an expert who has expertise on color adjustment of the printer 20 and is an administrator of the color management system 100.

The controller 11 restricts presentation of the first operation screen to a second user different from the first user among the users. The controller 11 restricts presentation of the first operation screen on the PC 10 used by the second user. In the present embodiment, the second user is a general user who has no specialized knowledge on color adjustment of the printer 20 and is an operator who is inexperienced with color adjustment.

The controller 11 preferentially presents the first operation screen to the first user among the users. On the PC 10 used by the first user, the controller 11 presents the first operation screen with priority over the second operation screen.

The controller 11 preferentially presents the second operation screen to the second user different from the first user among the users. On the PC 10 used by the second user, the controller 11 presents the second operation screen with priority over the first operation screen.

The controller 11 allows the first user to register a routine. Specifically, the controller 11 permits the first user to register a routine on the first operation screen.

The routine includes processing related to judgement on color matching. The judgement on color matching may be automatically performed by the apparatus (controller 11) or may be input by (obtained from) a person. Examples of color matching include color matching for a predetermined sheet, color matching in color verification, color matching based on a color sample, and color matching for a spot color.

In performing the routine, based on the result of processing related to judgement on color matching, the controller 11 determines the content of the subsequent color adjustment to be performed after the processing related to judgement on color matching.

The types of color adjustment (color adjustment items) include at least two among: in-plane unevenness adjustment, maximum density adjustment, single-color tone adjustment, mixed-color tone adjustment, generation of color conversion table, tone curve adjustment, adjustment of specified color conversion, adjustment of print sample scanning, spot color adjustment by colorimetry, spot color adjustment based on comparison of candidate colors, spot color adjustment by manual input, and color verification.

Conditions (e.g., printing conditions, colorimetry conditions, profile creation conditions, color verification conditions) in performing each type of color adjustment may be determined beforehand or may be set by a user when executing color adjustment.

Herein, various kinds of color adjustment will be described.

### In-Plane Unevenness Adjustment

In-plane unevenness adjustment is color adjustment for suppressing density unevenness of each color of CMYK on the sheet surface.

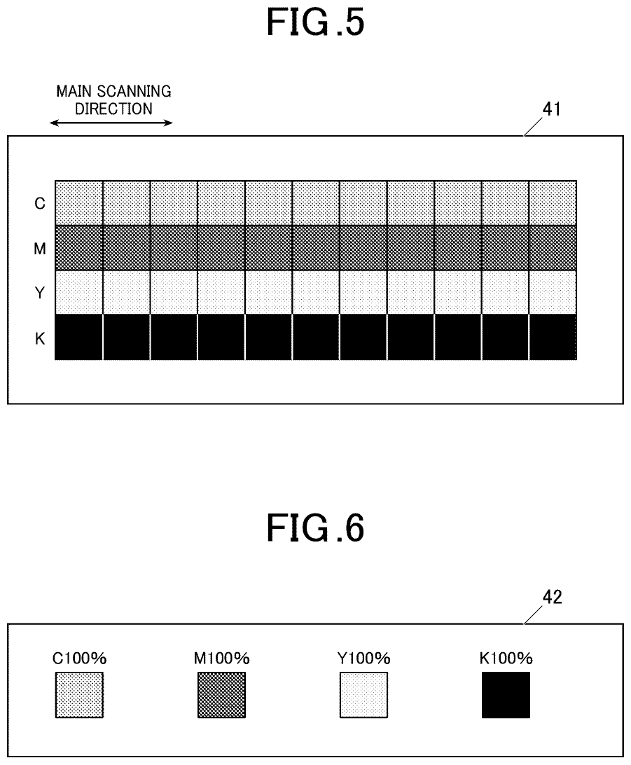

FIG. 5 shows an example of a colorimetry chart 41 for in-plane unevenness adjustment. In the colorimetry chart 41 for in-plane unevenness adjustment, multiple patches of the same color (each of the CMYK colors) are arranged in the main scanning direction. The main scanning direction is perpendicular to a direction in which the sheet is conveyed in the image forming section 26 of the printer 20.

In the in-plane unevenness adjustment, the controller 11 of the PC 10 sends an instruction to print the colorimetry chart 41 for in-plane unevenness adjustment to the target printer 20 that is the target of color adjustment target via the communication section 14.

At the printer 20, the controller 21 receives the instruction to print the colorimetry chart 41 for in-plane unevenness adjustment via the communication section 24. The controller 21 controls the image forming section 26 to print the colorimetry chart 41 for in-plane unevenness adjustment.

Next, the user sets the colorimetry chart 41 for in-plane unevenness adjustment to the reading device 30. The reading device 30 (colorimeter 31) measures the colorimetry chart 41 for in-plane unevenness adjustment and outputs the colorimetric values (L*a*b* values) of the respective patches.

The controller 11 of the PC 10 acquires the colorimetric values (L*a*b* values) of the respective patches of the colorimetry chart 41 for in-plane unevenness adjustment from the reading device 30 via the data acquiring section 16.

When the inline reading section 27 of the printer 20 performs colorimetry on the chart, the controller 11 of the PC 10 sends an instruction to read the colorimetry chart 41 for in-plane unevenness adjustment to the target printer 20 via the communication section 14. The controller 11 acquires information indicating whether the target printer 20 includes the inline reading section 27 from the printer table 153.

At the printer 20, the controller 21 receives the instruction to read the colorimetry chart 41 for in-plane unevenness adjustment via the communication section 24. The controller 21 controls the inline reading section 27 (colorimeter 28) to read the colorimetry chart 41 for in-plane unevenness adjustment.

The controller 11 of the PC 10 acquires the colorimetric values (L*a*b* values) corresponding to the respective patches of the colorimetry chart 41 for in-plane unevenness adjustment from the printer 20 via the communication section 14.

The controller 11 detects an in-plane unevenness in the main scanning direction for each color of CMYK, based on the colorimetric values corresponding to the respective patches of the colorimetry chart 41 for in-plane unevenness adjustment, which have been acquired from the reading device 30 or the printer 20 (inline reading section 27). The controller 11 calculates, for each of the CMYK colors, an adjustment value for correcting the detected in-plane unevenness.

### Maximum Density Adjustment

The maximum density adjustment is color adjustment with respect to the maximum density of each of CMYK colors.

FIG. 6 illustrates an example of a colorimetry chart 42 for maximum density adjustment. The colorimetry chart 42 for maximum density adjustment has patches of the respective CMYK colors having 100% color components.

Printing of the chart and acquisition of the colorimetric values of the respective patches of the chart are the same as in the in-plane unevenness adjustment.

Based on the colorimetric values corresponding to the respective patches of the colorimetry chart 42 for maximum density adjustment, the controller 11 of the PC 10 determines whether the maximum density is appropriate for each CMYK color. The controller 11 corrects the maximum density of each color as necessary.

### Single-Color Tone Adjustment

The single-color tone adjustment is color adjustment for the tones of CMYK single colors.

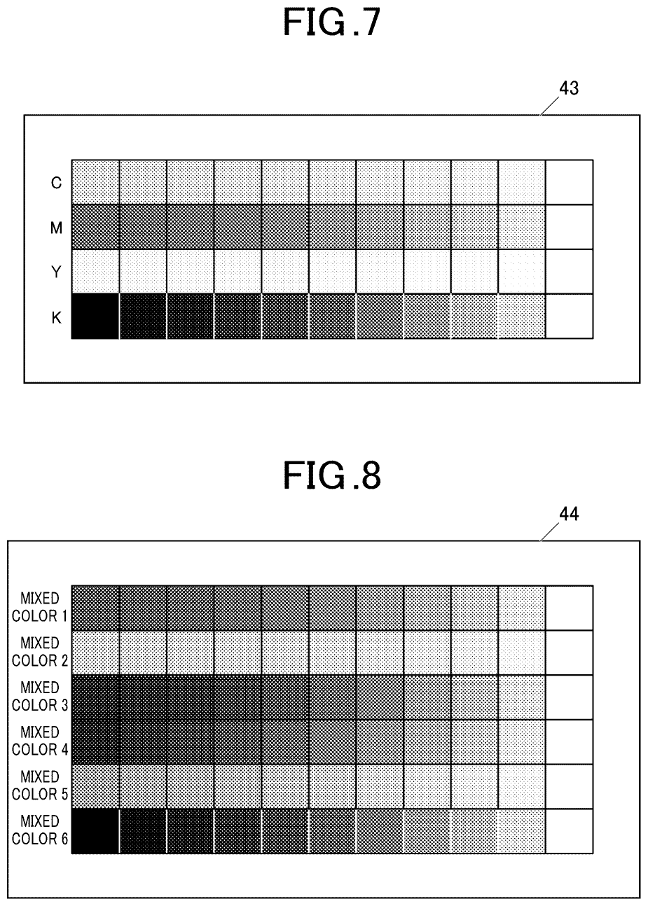

FIG. 7 shows an example of a colorimetry chart 43 for single-color tone adjustment. In the colorimetry chart 43 for single-color tone adjustment, for each of the CMYK colors, multiple patches having color components in the range of 0% to 100% are arranged at a regular interval.

Printing of the chart and acquisition of the colorimetric values of the respective patches of the chart are the same as in the in-plane unevenness adjustment.

The controller 11 of the PC 10 corrects the midtone of the single color (each of CMYK single colors), based on the colorimetric value corresponding to each patch of the colorimetry chart 43 for single-color tone adjustment.

### Mixed-Color Tone Adjustment

The mixed-color tone adjustment is color adjustment for the tones of the CMYK mixed colors. A mixed color is a mixture of multiple colors among C, M, Y, and K.

FIG. 8 illustrates an example of a colorimetry chart 44 for mixed-color tone adjustment. In the colorimetry chart 44 for mixed-color tone adjustment, for each mixed color of CMYK colors, multiple patches having tones (gradation) are arranged at a regular interval.

Printing of the chart and acquisition of the colorimetric values of the respective patches of the chart are the same as in the in-plane unevenness adjustment.

The controller 11 of the PC 10 corrects the midtone of the mixed color, based on the colorimetric value corresponding to each patch of the colorimetry chart 44 for mixed-color tone adjustment.

### Generation of Color Conversion Table

The generation of color conversion table is color adjustment in which a color conversion table (color profile) is generated.

The colorimetry chart for generation of color conversion table includes patches of several hundred colors or more.

Printing of the chart and acquisition of the colorimetric values of the respective patches of the chart are the same as in the in-plane unevenness adjustment.

Based on the colorimetric values corresponding to the respective patches of the colorimetry chart for generation of color conversion table, the controller 11 of the PC 10 generates a table (color profile) for converting an input color value into a CMYK value, which is to be output to the image forming section 26 of the printer 20. For example, the controller 11 generates a printer profile and a device link profile.

### Tone Curve Adjustment

The tone curve adjustment is adjustment of tone curves for the respective CMYK colors. The tone curves indicate output values with respect to input values.

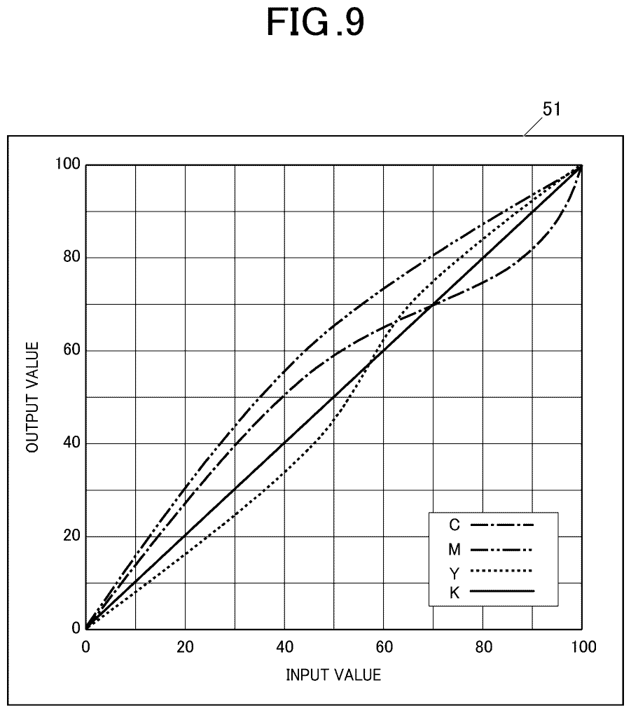

FIG. 9 shows an example of a tone curve adjustment screen 51 displayed on the display part 12 of the PC 10. On the adjustment screen 51, color reproduction curves of midtones (output values corresponding to input values) can be adjusted for the respective CMYK colors. For example, the user selects the color reproduction curve corresponding to the color to be adjusted and moves the point specified on the curve to an adjusted point by operating the operation part 13. In response to the operations on the operation part 13, the controller 11 adjusts the color reproduction curve.

### Adjustment of Specified Color Conversion

The adjustment of specified color conversion is color adjustment in a function of converting a specified color (CMYK value, RGB value) in document image data (e.g., PDF) into a predetermined CMYK value. The specified color conversion is affected by the adjustment of the color conversion table or the tone curve. The adjustment of specified color conversion includes “adjustment of specified color conversion based on comparison of candidate colors” and “adjustment of specified color conversion by manual input”.

### Spot Color Adjustment

The spot color adjustment is color adjustment in a function of converting a color (spot color) defined as a spot color name in the document image data into a CMYK value corresponding to the spot color name. The printer 20 has the conversion values (CMYK values) corresponding to the spot color names. The spot colors are not affected by the adjustment of the color conversion table or the tone curve. The spot color adjustment includes “spot color adjustment based on comparison of candidate colors”, “spot color adjustment by manual input”, and “spot color adjustment by colorimetry”.

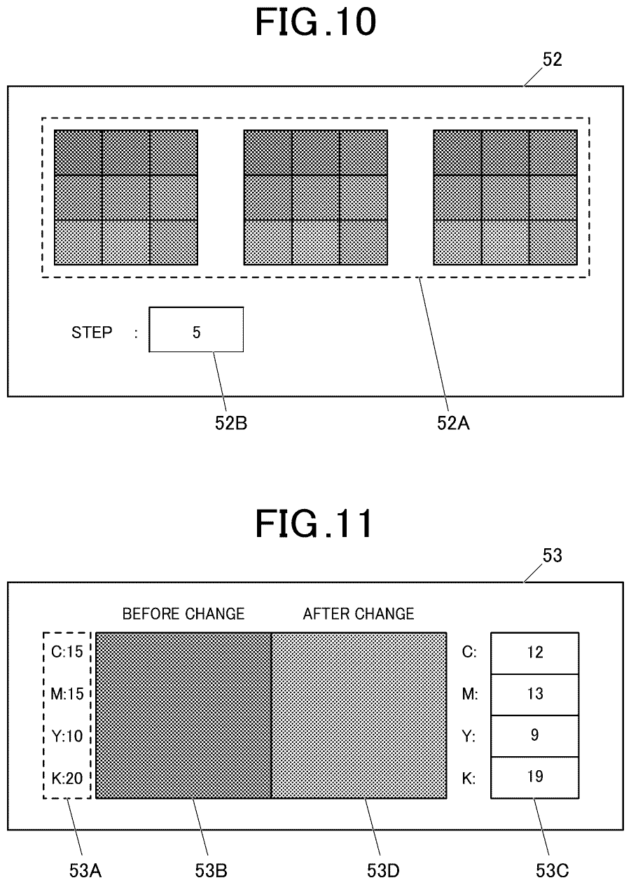

FIG. 10 illustrates an example of an adjustment screen 52 for “adjustment of specified color conversion based on comparison of candidate colors” or “spot color adjustment based on comparison of candidate colors” displayed on the display part 12 of the PC 10. The adjustment screen 52 includes a candidate color display field 52A and a step designation field 52B.

The candidate color display field 52A shows the current color (a CMYK value to which a specified color is converted or a CMYK value set as a spot color) and multiple peripheral colors (candidate colors) having slightly different CMYK values from the current color.

The step designation field 52B is for designating an interval (e.g., 5%) in changing the CMYK values. The user can change the numerical value of the step designation field 52B by operating the operation part 13.

The controller 11 of the PC 10 sends an instruction to print the chart including the candidate color patches displayed in the candidate color display field 52A to the target printer 20 via the communication section 14.

At the printer 20, the controller 21 receives the instruction to print the chart via the communication section 24. The controller 21 controls the image forming section 26 to print the chart.

The user visually checks the chart printed by the printer 20 and selects the most preferable color from the candidate colors in the chart. The most preferable color is most preferable as a color to which a specified color is converted or as a spot color. The user selects, in the candidate color display field 52A of the adjustment screen 52 on the display part 12 of the PC 10, a candidate color corresponding to the most preferable color in the chart by operating the operation part 13.

For another example, the controller 11 acquires the colorimetric value corresponding to each patch of the chart printed by the printer 20 from the reading device 30 or the printer 20 (inline reading section 27). From among the patches, the controller 11 automatically selects a color having the smallest color difference from a predetermined target value (a color into which the specified color is converted or a spot color).

The controller 11 adjusts the specified color or the spot color so that the specified color or the spot color is converted into the CMYK value corresponding to the color selected by the user or the CMYK value corresponding to the automatically selected color.

FIG. 11 illustrates an example of an adjustment screen 53 for “adjustment of specified color conversion by manual input” or “spot color adjustment by manual input” displayed on the display part 12 of the PC 10. The adjustment screen 53 includes a CMYK value display field 53A before change, a color display field 53B before change, a CMYK value input field 53C after change, and a color display field 53D after change.

In the CMYK value display field 53A before change, the current CMYK values (CMYK values into which the specified color is converted or CMYK values set as the spot color) are displayed.

The color display field 53B before change shows the color to be printed with the current CMYK values.

The CMYK value input field 53C after change is for the user to input CMYK values after change.

The color display field 53D after change displays the color to be printed with the CMYK values input in the CMYK value input field 53C after change.

The controller 11 of the PC 10 sends, to the target printer 20 via the communication section 14, an instruction to print the chart including the patch having the color displayed in the color display field 53D after change.

At the printer 20, the controller 21 receives the instruction to print the chart via the communication section 24. The controller 21 controls the image forming section 26 to print the chart.

The user visually checks the chart printed by the printer 20. When the color of the patch is appropriate as a color into which the designated color is converted or as a spot color, the user instructs to end the adjustment by operating the operation part 13 of the PC 10. On the other hand, when further adjustment is needed, the user changes the adjustment values in the CMYK value input field 53C after change by operating the operation part 13.

For another example, the controller 11 acquires, from the reading device 30 or the printer 20 (inline reading section 27), colorimetric values corresponding to the patch in the chart printed by the printer 20. The controller 11 calculates adjustment values for the respective colors of CMYK, based on the colorimetric values of the patch and predetermined target values (the color into which the specified color is converted or the spot color).

In the spot color adjustment by colorimetry, the spot color is measured to calculate and output CMYK values to the printer 20.

The user sets a color sample including the spot color to the reading device 30. The reading device 30 (colorimeter 31) measures the spot color and outputs colorimetric values (L*a*b* values) corresponding to the spot color.

The controller 11 of the PC 10 acquires the colorimetric values corresponding to the spot color from the reading device 30 via the data acquiring section 16. The controller 11 refers to the color conversion table (color profile) of the target printer 20 and calculates CMYK values (approximate values) for reproducing the spot color.

### Adjustment of Print Sample Scanning

The adjustment of print sample scanning is color adjustment for matching colors with a print sample (color sample). The print sample is a target printed material that has been printed. In the adjustment of print sample scanning, the print sample is scanned; colors included in the scanned image are associated with color values of document image data (CMYK values); and a color conversion table (color profile) is generated.

The controller 11 of the PC 10 acquires document image data (CMYK values) corresponding to the color sample (target printed material). The document image data corresponding to the color sample is image data from which the color sample has been printed. The document image data is provided by a customer.

The user sets the color sample to the reading device 30. The reading device 30 reads the color sample and generates read image data (L*a*b* values). The read image data (L*a*b* values) is obtained by converting the read image data (RGB values) generated by the scanner 32 into colorimetric values (L*a*b* values) using the scanner profile of the scanner 32.

The controller 11 of the PC 10 acquires the read image data (L*a*b* values) of the color sample from the reading device 30 via the data acquiring section 16.

The controller 11 generates a table in which CMYK values of the document image data are associated with L*a*b* values of the read image data of the color sample at each corresponding position. Thus, the controller 11 generates the target profile for converting the CMYK values of the document image data into device-independent color values (L*a*b* values).

Next, the controller 11 converts the document image data (CMYK values) into color values (L*a b* values) using the target profile. Next, the controller 11 converts the color values (L*a*b* values) into print image data (CMYK values) by using the printer profile of the target printer 20. The print image data (CMYK values) is used when the printer 20 performs printing. The printer profile indicates the output characteristics of the printer 20. The controller 11 sends the print image data to the target printer 20 via the communication section 14.

At the printer 20, the controller 21 controls the image forming section 26 to perform printing of the printed material, based on the print image data.

The user sets the printed material to the reading device 30. The reading device 30 reads the printed material and generates read image data (L*a*b* values). The read image data (L*a*b* values) is obtained by converting the read image data (RGB values) generated by the scanner 32 into colorimetric values (L*a*b* values) using the scanner profile of the scanner 32.

The controller 11 of the PC 10 acquires the read image data (L*a*b* values) of the printed material from the reading device 30 via the data acquiring section 16.

The controller 11 calculates the color difference between the read image data (L*a*b* values) of the printed material and the read image data (L*a*b* values) of the color sample at corresponding positions. The controller 11 determines whether the color difference (e.g., average color difference, maximum color difference) between the read image data of the printed material and the read image data of the color sample is equal to or less than a threshold value.

When the color difference is greater than the threshold value, the controller 11 corrects the printer profile of the target printer 20, based on the difference between the read image data of the printed material (L*a*b* values) and the read image data of the color sample (L*a*b* values). The controller 11 converts the document image data (CMYK values) into print image data (CMYK values) to be output to the printer 20 by using the target profile and the corrected printer profile. The controller 11 then sends the print image data to the printer 20 and causes the printer 20 to print a printed material again.

The above procedure is repeated until the color difference between the read image data of the printed material (L*a*b values) and the read image data of the color sample (L*a*b values) is equal to or less than the threshold value. Thus, the colors of the color sample are reproduced on the printed material output by the printer 20.

### Color Verification

In the color verification, colorimetry is performed on a color verification chart having patches of multiple colors, and the colorimetric values are compared with reference values set beforehand. When the colorimetric values are within the reference values, the color verification result is “pass”. When the colorimetric values are not within the reference values, the color verification result is “fail”.

The controller 11 of the PC 10 sends an instruction to print the color verification chart to the target printer 20 via the communication section 14.

Printing of the chart and acquisition of the colorimetric values of the respective patches of the chart are the same as in the in-plane unevenness adjustment.

The storage section 15 of the PC 10 stores reference values for color verification. For example, the storage section 15 stores an allowable value for each verification item.

Based on the colorimetric values (L*a*b* values) corresponding to the respective patches of the color verification chart, the controller 11 determines whether the color reproduction by the printer 20 satisfies the color verification standard. Specifically, the controller 11 performs color verification by comparing the colorimetric values of the respective patches of the color verification chart with the reference values.

In each type of color adjustment described above, the controller 11 of the PC 10 sends the calculated adjustment values, the color conversion table (color profile), and the tone curve to the target printer 20 via the communication section 14.

The controller 21 of the printer 20 receives the adjustment values, the color conversion table, and the tone curve via the communication section 24 and registers the received data in the storage section 25. Thereafter, the controller 21 performs image formation using the adjustment values, the color conversion table, and the tone curve stored in the storage section 25.

The routines to be specified on the second operation screen include at least one of a first routine, a second routine, a third routine, and a fourth routine.

The first routine is for performing color matching for a predetermined sheet.

In the first routine, first, the controller 11 executes at least two among the in-plane unevenness adjustment, maximum density adjustment, single-color tone adjustment, mixed-color tone adjustment, generation of color conversion table, and tone curve adjustment with respect to the target printer 20. The controller 11 then performs processing related to judgement on color matching for the target printer 20. Based on the result of the processing related to judgement on color matching, the controller 11 performs at least one of the in-plane unevenness adjustment, maximum density adjustment, single-color tone adjustment, mixed-color tone adjustment, generation of color conversion table, and tone curve adjustment for the target printer 20.

The second routine is for performing color verification and color adjustment, based on the color verification result.

In the second routine, first, the controller 11 performs color verification for the target printer 20. Based on the result of judgement on color matching in the color verification, the controller 11 performs at least one of the in-plane unevenness adjustment, maximum density adjustment, single-color tone adjustment, mixed-color tone adjustment, generation of color conversion table, and tone curve adjustment for the target printer 20.

The third routine is for performing color matching, based on a color sample as a printed material.

In the third routine, first, the controller 11 performs adjustment of print sample scanning for the target printer 20. Based on the result of adjustment of print sample scanning, the controller 11 performs at least either the tone curve adjustment or the adjustment of specified color conversion for the target printer 20.

The fourth routine is for performing color matching for spot color.

In the fourth routine, first, the controller 11 performs at least two among the spot color adjustment by colorimetry, spot color adjustment based on comparison of candidate colors, and spot color adjustment by manual input, for the target printer 20.

### Operation of Color Management System

Next, operation of the color management system 100 will be described.

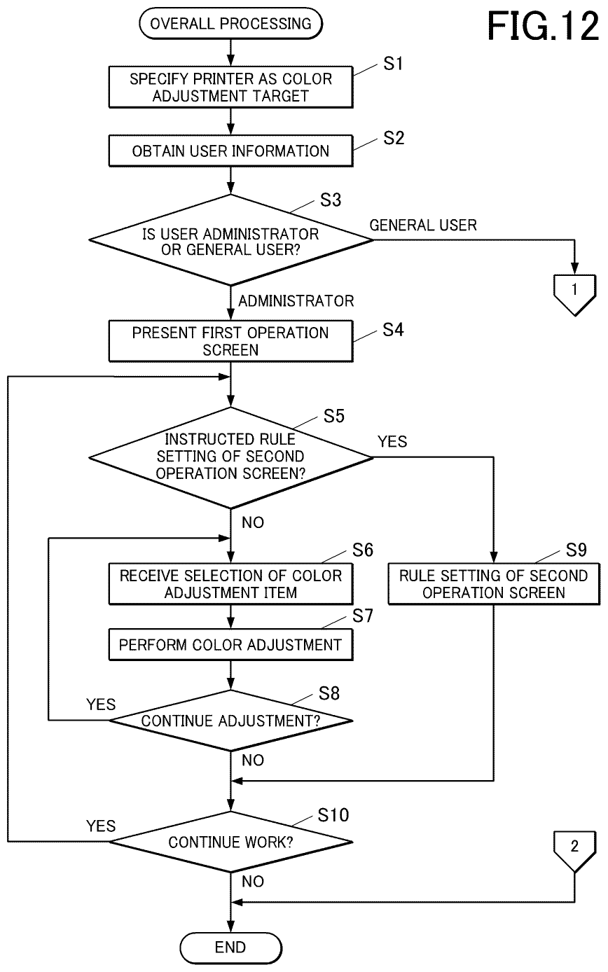

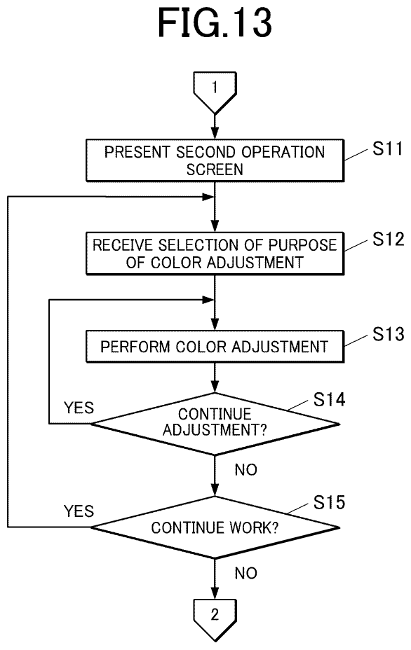

FIG. 12 and FIG. 13 illustrate a flowchart of overall processing to be performed by the PC 10. This processing is realized by software processing performed by the controller 11 in cooperation with the color adjustment application program 151 stored in the storage section 15.

First, the controller 11 of the PC 10 receives designation of the printer 20 as a color adjustment target by the user operating the operation part 13 (step S1).

Next, the controller 11 acquires user information of the user who is using the PC 10 (step S2). Specifically, the controller 11 refers to the user table 152 and acquires user information (e.g., attributes) corresponding to the username input by the user when logging in to the PC 10.

Based on the attribute (administrator/general user) in the user information acquired in step S2, the controller 11 determines whether the user is an administrator (skilled person) or a general user (beginner) (step S3).

When the user using the PC 10 is an administrator (step S3: administrator), the controller 11 presents the first operation screen on the display part 12 (step S4). The first operation screen is a color adjustment selection screen for the administrator. On the first operation screen, multiple types of color adjustment can be individually specified.

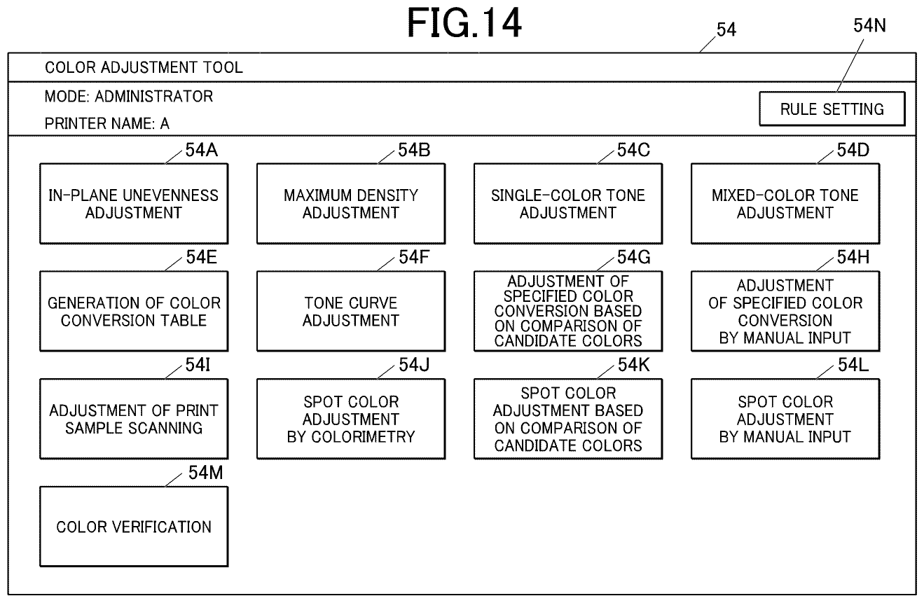

FIG. 14 illustrates an example of the first operation screen 54 displayed on the display part 12. On the first operation screen 54, the user individually selects and executes functions corresponding to the purpose from among various independent color adjustment functions. The user also determines the execution order of color adjustment.

The first operation screen 54 includes color adjustment item buttons 54A to 54M. The color adjustment item button 54A is for selecting “in-plane unevenness adjustment”. The color adjustment item button 54B is for selecting “maximum density adjustment”. The color adjustment item button 54C is for selecting “single-color tone adjustment”. The color adjustment item button 54D is for selecting “mixed-color tone adjustment”. The color adjustment item button 54E is for selecting “generation of color conversion table”. The color adjustment item button 54F is for selecting “tone curve adjustment”. The color adjustment item button 54G is for selecting “adjustment of specified color conversion based on comparison of candidate colors”. The color adjustment item button 54H is for selecting “adjustment of specified color conversion by manual input”. The color adjustment item button 54I is for selecting “adjustment of print sample scanning”. The color adjustment item button 54J is for selecting “spot color adjustment by colorimetry”. The color adjustment item button 54K is for selecting “spot color adjustment based on comparison of candidate colors”. The color adjustment item button 54L is for selecting “spot color adjustment by manual input”. The color adjustment item button 54M is for selecting “color verification”.

The first operation screen 54 also includes a rule setting button 54N. The rule setting button 54N is for giving an instruction to set rules of the second operation screen.

Next, the controller 11 determines, on the first operation screen, whether the rule setting of the second operation screen has been instructed by the user operating the operation part 13 (step S5). Specifically, the controller 11 determines whether the rule setting button 54N has been pressed on the first operation screen 54 (see FIG. 14).

When the rule setting of the second operation screen is not instructed (step S5: NO), the controller 11 receives selection of a color adjustment item from among multiple types of color adjustment items by the user operating the operation part 13 (step S6). Specifically, the controller 11 receives selection of one of the color adjustment item buttons 54A to 54M on the first operation screen 54 (see FIG. 14).

Next, the controller 11 executes color adjustment for the target printer 20 with respect to the selected color adjustment item (step S7). Details of the respective types of color adjustment are described above.

Next, the controller 11 determines whether to continue the adjustment (step S8). When the user gives an instruction to end the adjustment by operating the operation part 13, the controller 11 determines not to continue the adjustment. When the adjustment is to be continued (step S8: YES), the controller 11 returns to step S6. When the color adjustment does not end with one color adjustment item, the user selects another color adjustment item.

In step S5, when rule setting of the second operation screen has been instructed (step S5: YES), the controller 11 performs rule setting of the second operation screen (step S9). Specifically, when the user presses the rule setting button 54N on the first operation screen 54 (see FIG. 14) by operating the operation part 13, the controller 11 displays a setting screen on the display part 12. For example, for the routines corresponding to the respective color adjustment purposes, the controller 11 determines ON/OFF of each color adjustment function, based on the user's operation on the operation part 13. The controller 11 does not accept a change for a color adjustment item whose ON/OFF is unchangeable. Further, for the color adjustment functions the order of which is changeable in each routine, the controller 11 sets the execution order of the color adjustment functions, based on the user's operation on the operation part 13. The controller 11 stores the determined contents in the rule setting table 154 (see FIG. 4) of the storage section 15. As described above, the controller 11 permits the registration of the routine in response to the operation on the first operation screen by the administrator.

When the adjustment is not to be continued (step S8: NO) or after step S9, the controller 11 determines whether to continue work (step S10). When the user gives an instruction to end the work by operating the operation part 13, the controller 11 determines not to continue the work. If the work is to be continued (step S10: YES), the controller 11 returns to step S5.

In step S3, if the user using the PC 10 is a general user (step S3: general user), the controller 11 proceeds to FIG. 13. The controller 11 presents the second operation screen on the display part 12 (step S11). The second operation screen is a color adjustment selection screen for general users. On the second operation screen, one of the routines (color adjustment purposes) can be specified.

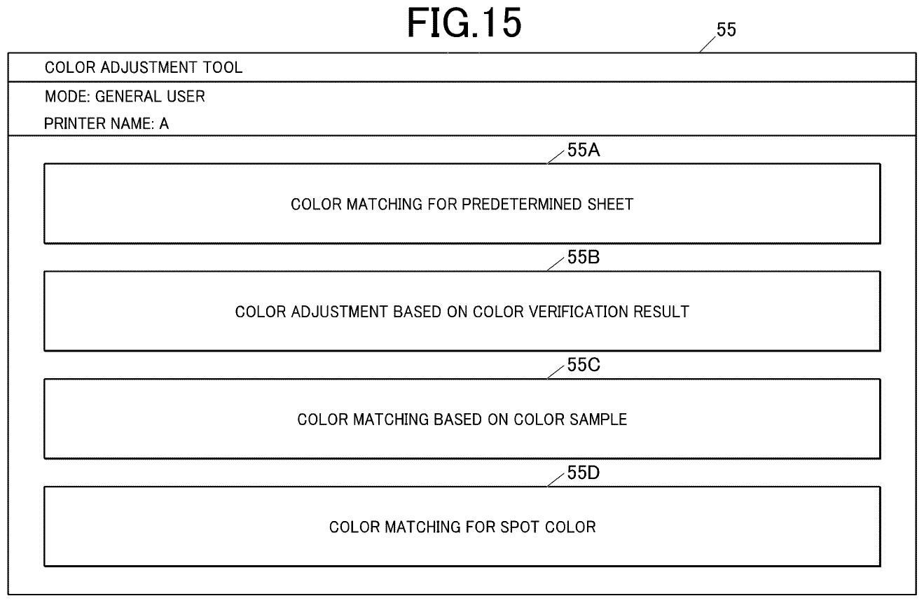

FIG. 15 shows an example of the second operation screen 55 to be displayed on the display part 12. On the second operation screen 55, the user selects a color adjustment purpose instead of selecting individual color adjustment functions. Accordingly, the user performs multiple color adjustment functions in accordance with a procedure prepared beforehand.

The second operation screen 55 includes color adjustment purpose buttons 55A to 55D. The color adjustment purpose button 55A is for selecting “color matching for predetermined sheet” as a color adjustment purpose. The color adjustment purpose button 55B is for selecting “color adjustment based on color verification result” as a color adjustment purpose. The color adjustment purpose button 55C is for selecting “color matching based on color sample” as a color adjustment purpose. The color adjustment purpose button 55D is for selecting “color matching for spot color” as a color adjustment purpose.

Next, the controller 11 receives, on the second operation screen, selection of a color adjustment purpose by the user operating the operation part 13 (step S12). Specifically, the controller 11 receives selection of any one of the color adjustment purpose buttons 55A to 55D on the second operation screen 55 (see FIG. 15).

Next, the controller 11 performs, for the target printer 20, the color adjustment functions included in the routine of the selected color adjustment purpose according to the order (step S13). Specifically, the controller 11 refers to the rule setting table 154 and performs the color adjustment functions in accordance with the rules set for the selected color adjustment purpose. When the order of some color adjustment functions is determined in the routine corresponding to the color adjustment purpose, the controller 11 performs the color adjustment functions in the determined order. When the order is not determined for the color adjustment functions in the routine corresponding to the color adjustment purpose, the controller 11 performs the color adjustment functions set to “ON” in the rule setting table 154 in the order from the top of the table. Details of the respective color adjustment functions are described above.

Next, the controller 11 determines whether to continue the adjustment (step S14). When all the color adjustment functions included in the routine corresponding to the selected color adjustment purpose have been performed, the controller 11 determines not to continue the adjustment. When all the color adjustment functions in the routine have not been performed but the color adjustment purpose is achieved, the controller 11 can end the adjustment. For example, the controller 11 automatically determines whether the color adjustment is sufficiently performed for the selected color adjustment purpose, based on the colorimetry result. When the adjustment is sufficient, the controller 11 determines not to continue the adjustment. For another example, when the user visually confirms that the color adjustment is sufficiently performed for the selected color adjustment and gives an instruction to end the adjustment with the operation part 13, the controller 11 determines not to continue the adjustment.

When the adjustment is to be continued (step S14: YES), the controller 11 returns to step S13. The color adjustment functions performed in step S13 are automatically determined according to the selected color adjustment purpose.

In step S14, when the adjustment is not to be continued (step S14: NO), the controller 11 determines whether to continue the work (step S15). When the user gives an instruction to end the work by operating the operation part 13, the controller 11 determines not to continue the work. If the work is to be continued (step S15: YES), the controller 11 returns to step S12. The user selects another color adjustment purpose.

When the work is not to be continued in Step S10 or Step S15 (Step S10: NO/Step S15: NO), the overall processing ends.

In the overall processing, the controller 11 determines which to present, the first operation screen or the second operation screen, based on the attribute of the user who is using the PC 10. For another example, the controller 11 may cause the display part 12 to display options of “administrator” and “general user”, and the user may select “administrator” or “general user” by operating the operation part 13. In this case, the controller 11 determines which to present, the first operation screen (for the administrator) or the second operation screen (for the general user), according to “administrator” or “general user” selected by the user.

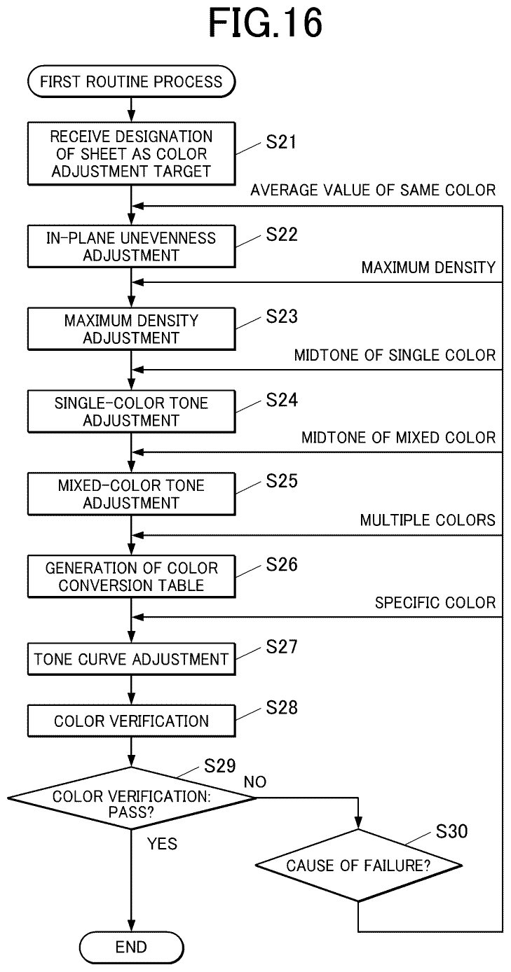

FIG. 16 is a flowchart of the first routine process performed by the PC 10. The first routine process is performed in a case where “color matching for predetermined sheet” is selected as the color adjustment purpose on the second operation screen in step S12 of the overall processing (refer to FIG. 12 and FIG. 13).

In the first routine process, the controller 11 executes the color adjustment functions (except color verification) set to “ON” as the rule of “color matching for predetermined sheet” in the rule setting table 154 in the order from the top of the table. The controller 11 then performs the color verification at the end. When the color verification result is “fail”, the controller 11 determines the cause of failure and performs the process from the necessary color adjustment function.

First, the controller 11 receives designation of a predetermined sheet to be subjected to color adjustment by the user operating the operation part 13 (step S21). For example, as the predetermined sheet, a sheet size, a sheet type, a basis weight, and a sheet color are specified. The controller 11 sets the specified sheet as a sheet to be used for color matching.

Next, the controller 11 executes in-plane unevenness adjustment for the target printer 20 by using the predetermined sheet (step S22).

Next, the controller 11 executes the maximum density adjustment for the target printer 20 using the predetermined sheet (step S23).

Next, the controller 11 executes single-color tone adjustment for the target printer 20 using the predetermined sheet (step S24).

Next, the controller 11 executes mixed-color tone adjustment for the target printer 20 using the predetermined sheet (step S25).

Next, the controller 11 executes generation of color conversion table for the target printer 20 using the predetermined sheet (step S26).

Next, the controller 11 executes tone curve adjustment for the target printer 20 using the predetermined sheet (step S27).

Next, the controller 11 executes color verification for the target printer 20 using the predetermined sheet (step S28). Details of the respective color adjustment functions in step S22 to step S28 are described above.

Next, the controller 11 determines whether the color verification result is “pass” (step S29). When the color verification result is not “pass” (step S29: NO), the controller 11 determines the cause of the failure (step S30).

In a case where the average value of the same color (any of CMYK colors) does not satisfy the standard in the color verification result, in-plane unevenness adjustment is needed. For example, for any of CMYK colors, when the variation in the average values of the colorimetric values of the respective patches having the same color component is greater than a predetermined value, it is considered that in-plane unevenness has occurred.

When, for any of CMYK colors, the maximum density does not meet the standard, the maximum density adjustment is needed.

When the midtone of a single color does not satisfy the standard, single-color tone adjustment is needed.

When the midtone of a mixed color does not satisfy the standard, mixed-color tone adjustment is needed.

When, for each patch included in the color verification chart, multiple colors do not satisfy the standard, the color conversion table (color profile) needs to be regenerated.

When a specific color among CMYK colors does not satisfy the standard, tone curve adjustment is needed.

In step S30, when the cause of failure is that the average value of the same color does not satisfy the standard (step S30: average value of the same color), the controller 11 proceeds to step S22.

In Step 30, when the cause of failure is that the maximum density does not satisfy the standard (step S30: maximum density), the controller 11 proceeds to step S23.

In Step S30, when the cause of failure is that the midtone of a single color does not satisfy the standard (step S30: midtone of single color), the controller 11 proceeds to step S24.

In step S30, when the cause of failure is that the midtone of a mixed color does not satisfy the standard (step S30: midtone of mixed color), the controller 11 proceeds to step S25.

In step S30, when the cause of failure is that multiple colors do not satisfy the standard (step S30: multiple colors), the controller 11 proceeds to step S26.

In step S30, when the cause of failure is that a specific color does not satisfy the standard (step S30: specific color), the controller 11 proceeds to step S27.

In step S29, when the color verification result is “pass” (step S29: YES), the first routine process ends.

In the first routine process illustrated in FIG. 16, the controller 11 executes in-plane unevenness adjustment, maximum density adjustment, single-color tone adjustment, mixed-color tone adjustment, generation of color conversion table, and tone curve adjustment, by using the predetermined sheet. The controller 11 then executes color verification (processing related to judgement on color matching). Next, based on the result of the color verification, when the color verification result is “fail”, the controller 11 executes at least one of the in-plane unevenness adjustment, maximum density adjustment, single-color tone adjustment, mixed-color tone adjustment, generation of color conversion table, and tone curve adjustment.

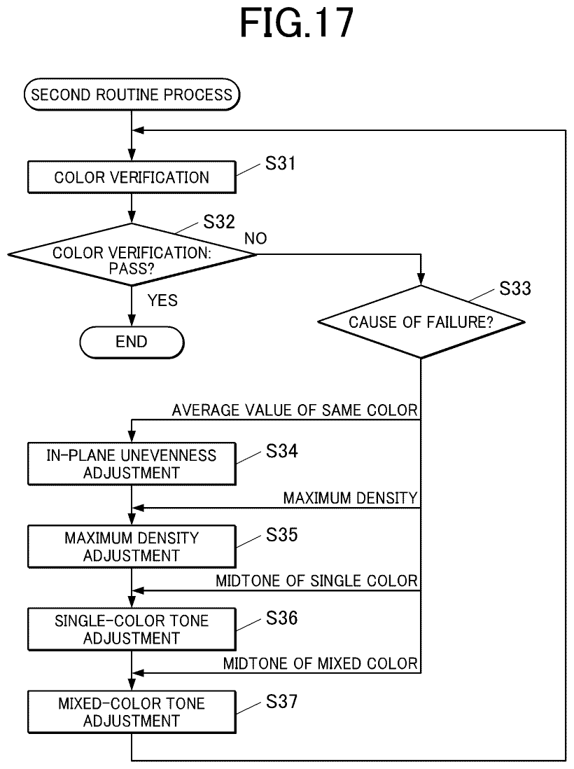

FIG. 17 is a flowchart of the second routine process to be executed by the PC 10. The second routine process is executed in a case where “color adjustment based on color verification result” is selected as the color adjustment purpose on the second operation screen in step S12 of the overall processing (see FIG. 12 and FIG. 13).

In the second routine process, the controller 11 first executes color verification. When the color verification result is “pass”, the controller 11 ends the process. When the color verification result is “fail”, the controller 11 determines the cause of failure and executes the color adjustment functions (except color verification) set to “ON” in the rule of “color adjustment based on color verification result” in the rule setting table 154 in order from the top of the table. The controller 11 omits execution of unnecessary color adjustment functions, depending on the cause of failure.

First, the controller 11 executes color verification for the target printer 20 (step S31). Details of the color verification are described above.

Next, the controller 11 determines whether the color verification result is “pass” (step S32). Here, the color verification result corresponds to the “result of judgement on color matching in color verification”. When the color verification result is not “pass” (step S32: NO), the controller 11 determines the cause of failure (step S33).

When the cause of failure is that the average value of the same color does not satisfy the standard (step S33: average value of same color), the controller 11 executes in-plane unevenness adjustment for the target printer 20 (step S34).

After step S34 or when in Step S33 the cause of failure is that the maximum density does not satisfy the standard (step S33: maximum density), the controller 11 executes the maximum density adjustment for the target printer 20 (step S35).

After step S35 or when in Step S33 the cause of failure is that the midtone of a single color does not satisfy the standard (step S33: midtone of single color), the controller 11 executes the single-color tone adjustment for the target printer 20 (step S36).

After step S36 or when in step S33 the cause of failure is that the midtone of a mixed color does not satisfy the standard (step S33: midtone of mixed color), the controller 11 executes mixed-color tone adjustment for the target printer 20 (step S37).

Details of the respective color adjustment functions in steps S34 to S37 are described above.

After step S37, the controller 11 proceeds to step S31.

In step S32, when the color verification result is “pass” (step S32: YES), the second routine process ends.

In the second routine process shown in FIG. 17, the controller 11 executes color verification. Thereafter, based on the judgement result of color matching in color verification, when the color verification result is “fail”, the controller 11 executes at least one of the in-plane unevenness adjustment, maximum density adjustment, single-color tone adjustment, and mixed-color tone adjustment.

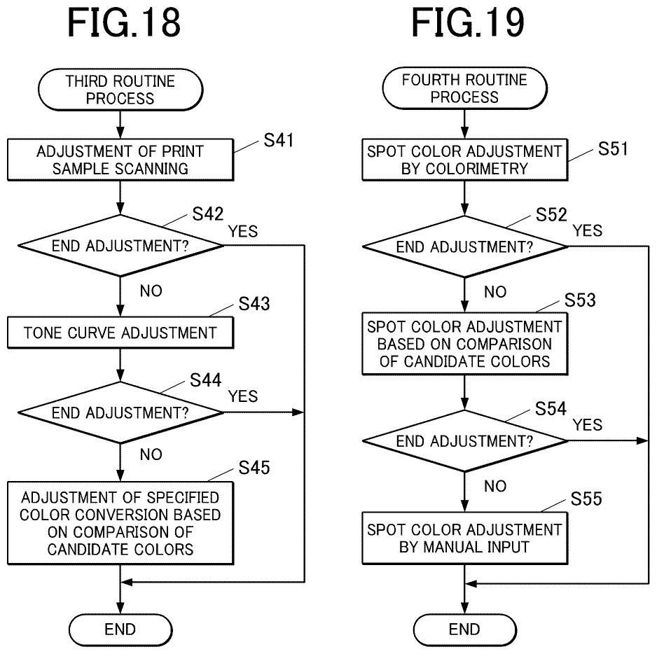

FIG. 18 is a flowchart of the third routine process to be executed by the PC 10. The third routine process is executed in a case where “color matching based on color sample” is selected as the color adjustment purpose on the second operation screen in step S12 of the overall processing (refer to FIG. 12 and FIG. 13).

In the third routine process, the controller 11 executes the color adjustment functions set to “ON” in the rule of “color matching based on color sample” in the rule setting table 154 in the determined order. The controller 11 may end the adjustment in the middle of the process (steps S42 and S44) without executing all the color adjustment functions.

First, the controller 11 executes the adjustment of print sample scanning for the target printer 20 (step S41). Details of the adjustment of print sample scanning are described above.

Next, the controller 11 determines whether to end the adjustment (step S42). For example, when the color difference between the colorimetric value and a predetermined target value is less than or equal to a reference value, the controller 11 determines to end the adjustment. For another example, when the user visually confirms that “color matching based on color sample” is sufficient and gives an instruction to end the adjustment with the operation part 13, the controller 11 determines to end the adjustment.

If the adjustment is not to be ended (step S42: NO), the controller 11 executes tone curve adjustment for the target printer 20 (step S43). Details of the tone curve adjustment are described above.

Next, the controller 11 determines whether to end the adjustment (step S44). Details of the determination are the same as in step S42.

When the adjustment is not to be ended (step S44: NO), the controller 11 executes the adjustment of specified color conversion based on comparison of candidate colors for the target printer 20 (step S45). Details of the adjustment of specified color conversion based on comparison of candidate colors are described above.

After step S45 or when in Step S42 the adjustment is to be ended (step S42: YES) or when in Step S44 the adjustment is to be ended (step S44: YES), the third routine process ends.

In the third routine process shown in FIG. 18, the controller 11 executes the adjustment of print sample scanning. Based on the result of the adjustment of print sample scanning, when the controller 11 determines that the color matching based on the color sample (print sample) is not sufficient, the controller 11 proceeds to “NO” in step S42 and performs at least the tone curve adjustment.

In the third routine process, the controller 11 may execute “tone curve adjustment” and “adjustment of specified color conversion based on comparison of candidate colors”, based on the result of the adjustment of print sample scanning. Further, the controller 11 may execute “adjustment of specified color conversion based on comparison of candidate colors”, based on the result of the adjustment of print sample scanning. Further, the controller 11 may execute “adjustment of Specified color conversion by manual input” instead of “adjustment of specified color conversion based on comparison of candidate colors”.

FIG. 19 is a flowchart of the fourth routine process to be executed by the PC 10. The fourth routine process is executed in a case where “color matching for spot color” has been selected as the color adjustment purpose on the second operation screen in step S12 of the overall processing (refer to FIG. 12 and FIG. 13).

In the fourth routine process, the controller 11 executes the color adjustment functions set to “ON” in the rule of “color matching for spot color” in the rule setting table 154 in the determined order. The controller 11 may end the adjustment in the middle of the process (steps S52 and S54) without executing all the color adjustment functions.

First, the controller 11 executes spot color adjustment by colorimetry on the target printer 20 (step S51). The details of the spot color adjustment by colorimetry are described above.

Next, the controller 11 determines whether to end the adjustment (step S52). For example, when the color difference between the colorimetric value and a predetermined target value is less than or equal to a reference value, the controller 11 determines to end the adjustment. For another example, when the user visually confirms that the “color matching for spot color” is sufficient and instructs to end the adjustment by operating the operation part 13, the controller 11 determines to end the adjustment.

When the adjustment is not to be ended (step S52: NO), the controller 11 executes spot color adjustment based on comparison of candidate colors for the target printer 20 (step S53). Details of the spot color adjustment based on comparison of candidate colors are described above.

Next, the controller 11 determines whether to end the adjustment (step S54). Details of the determination are the same as in step S52.

When the adjustment is not to be ended (step S54: NO), the controller 11 executes the spot color adjustment by manual input for the target printer 20 (step S55). Details of the spot color adjustment by manual input are described above.

After step S55 or when in Step S52 the adjustment is to be ended (step S52: YES) or when in Step S54 the adjustment is to be ended (step S54: YES), the fourth routine process ends.

In the fourth routine process of FIG. 19, the controller 11 executes the “spot color adjustment by colorimetry”. When determining that the color matching for spot color is insufficient, the controller 11 executes the “spot color adjustment based on comparison of candidate colors”. Thereafter, when the determining that the color matching for spot color is not sufficient, the controller 11 executes “spot color adjustment by manual input”.

In the fourth routine process, the controller 11 may sequentially execute the process of steps S51, S53, and S55 without performing the determination of steps S52 and S54. Further, the controller 11 may omit any one of steps S51, S53, and S55.

As described above, according to the present embodiment, the controller 11 of the PC 10 presents the first operation screen for designating individual types of color adjustment. The controller 11 presents the second operation screen for designating a routine including at least two types of color adjustment among multiple types of color adjustment. That is, the PC 10 has the user interface for general users different from the user interface for an administrator. When the user designates a predetermined routine on the second operation screen, the user can perform at least two types of color adjustment included in the designated routine. Thus, the controller 11 allows users without specialized knowledge to perform color adjustment including a combination of multiple types of color adjustment.

The controller 11 controls presentation of the first operation screen and the second operation screen depending on the user using the PC 10. The controller 11 can provide the user with a comfortable execution of color adjustment by presenting the operation screen corresponding to the user. On the second operation screen, the user does not need to designate individual types of color adjustment to be executed or consider the execution order of color adjustment.

Specifically, the controller 11 permits the first user (administrator) to perform operation on the first operation screen. On the other hand, the controller 11 restricts presentation of the first operation screen to the second user (general user). Thus, the controller 11 allows the first user to perform flexible and professional color adjustment. The controller 11 can prevent the second user from performing color adjustment that requires specialized knowledge.

The controller 11 preferentially presents the first operation screen to the first user (administrator) and preferentially presents the second operation screen to the second user (general user). Thus, the controller 11 allows the first user to perform flexible and professional color adjustment. On the other hand, the controller 11 allows the second user to perform color adjustment including a combination of multiple types of color adjustment by simply allowing the second user to designate a routine. For example, the controller 11 can determine the operation screen to be presented to the user when the color adjustment application is activated.

The controller 11 allows the first user (administrator) to register a routine. Thus, the controller 11 allows the first user to set rules of routines that can be specified on the second operation screen. The rules include types of color adjustment to be included in the routine, the execution order of the types of color adjustment, and so forth.

For example, the controller 11 allows registration of a routine on the first operation screen, thereby preventing the second user (general user) from registering a routine.

In performing the routine, based on the result of processing related to judgement on color matching, the controller 11 determines the contents of the subsequent color adjustment to be performed after the processing related to judgement on color matching. Since the controller 11 flexibly performs color adjustment based on the result of processing, the controller 11 can provide advanced color adjustment for users without specialized knowledge.

The controller 11 can provide the first routine, the second routine, the third routine, and the fourth routine as routines that can be designated on the second operation screen.

When the first routine is designated, the controller 11 can provide the routine for color matching for predetermined sheet.

When the second routine is specified, the controller 11 can provide the routine for executing color verification and performing color adjustment based on the color verification result.

When the third routine is specified, the controller 11 can provide the routine for performing color matching based on a color sample as a printed material.

When the fourth routine is specified, the controller 11 can provide the routine for performing color matching for spot color.

The embodiment described above is an example of the color adjustment management method, the color adjustment management apparatus, and the program according to the present disclosure. The present disclosure is not limited thereto. The detailed configuration and the detailed operation of each part forming the apparatus can also be appropriately changed without departing from the spirit of the present disclosure.

For example, in the above embodiment, the processes performed by the controller 11 (color adjustment application) of the PC 10 may be performed by any of the printers 20 or a device connectable to the color management system 100. Furthermore, each process performed by the controller 11 (color adjustment application) of the PC 10 may be performed by multiple devices in cooperation with each other.

Furthermore, the combination of types of color adjustment included in each routine, the order of types of color adjustment included in each routine, and the color adjustment purposes corresponding to the respective routines are not limited to the above-described examples.

In the above embodiment, the controller 11 of the PC 10 presents the first operation screen to the first user (administrator) and presents the second operation screen to the second user (general user). That is, the controller 11 restricts presentation of the first operation screen to the second user by prohibiting display of the first operation screen to the second user. For another example, the controller 11 may display the first operation screen on the display part 12 for the second user but prohibit the second user from performing operation on the second screen with the operation part 13. For example, on the first operation screen, the controller 11 may indicate color adjustment items for which the second user is not allowed to make operation by graying out the color adjustment items.

When presenting the operation screen, the controller 11 may provide different explanations on the first operation screen and the second operation screen for explaining operation related to color adjustment. For example, when presenting the second operation screen, the controller 11 may display a more detailed description of operation on the display part 12 than when presenting the first operation screen. Thus, the controller 11 can appropriately support the second user (general user).

In the above embodiment, the printer 20 is an electrophotographic image forming apparatus. However, the printer 20 is not limited thereto. For example, the printer 20 may be an inkjet image forming apparatus.

In the above embodiment, the color adjustment application program 151 is locally installed in the PC 10. For another example, the color adjustment application may be provided on the cloud in the form of software as a service (SaaS), and the PC 10 may use the application via a browser.

Further, various kinds of data stored in the storage section 15 of the PC 10 may be stored in an external device in a way the controller 11 can use the data.

The computer-readable medium that stores the program for executing the processes is not limited to the above-described example. Furthermore, a carrier wave may be applied as a medium for providing data of the program via a communication line.

Although the embodiment of the present invention has been described and illustrated in detail, the disclosed embodiment is made for purposes of illustration and example only and not limitation. The scope of the present invention should be interpreted by terms of the appended claims.

What is claimed is:

1. A color adjustment management method to be performed by a color adjustment management apparatus that manages multiple types of color adjustment for an image forming apparatus, the method comprising:
presenting a first operation screen for individually designating the multiple types of color adjustment, and;
presenting a second operation screen for designating a routine including at least two types of color adjustment among the multiple types of color adjustment.

2. The color adjustment management method according to claim 1, wherein:
the color adjustment management apparatus is usable by multiple users, and
the color adjustment management apparatus controls presentation of the first operation screen and the second operation screen depending on a user using the color adjustment management apparatus.

3. The color adjustment management method according to claim 2, wherein the color adjustment management apparatus:
permits a first user among the users to perform operation on the first operation screen and
restricts presentation of the first operation screen to a second user different from the first user among the users.

4. The color adjustment management method according to claim 2, wherein the color adjustment management apparatus:
presents the first operation screen preferentially to a first user among the users and
presents the second operation screen preferentially to a second user different from the first user among the users.

5. The color adjustment management method according to claim 3, wherein the color adjustment management apparatus permits the first user to register the routine.

6. The color adjustment management method according to claim 5, wherein the color adjustment management apparatus permits the first user to register the routine on the first operation screen.

7. The color adjustment management method according to claim 1, wherein:
the routine includes processing related to judgement on color matching, and
based on a result of the processing related to judgement on color matching, the color adjustment management apparatus determines a content of color adjustment to be performed after the processing in performing the routine.

8. The color adjustment management method according to claim 1, wherein the multiple types of color adjustment include at least two among in-plane unevenness adjustment, maximum density adjustment, single-color tone adjustment, mixed-color tone adjustment, generation of a color conversion table, tone curve adjustment, adjustment of specified color conversion, adjustment of print sample scanning, spot color adjustment by colorimetry, spot color adjustment based on comparison of candidate colors, spot color adjustment by manual input, and color verification.

9. The color adjustment management method according to claim 1, wherein the routine includes at least one of following routines:
a first routine for color matching for a predetermined sheet,
a second routine for performing color verification and performing color adjustment based on a result of the color verification,
a third routine for performing color matching based on a color sample that is a printed material, and
a fourth routine for performing color matching for a spot color.

10. The color adjustment management method according to claim 9, wherein in the first routine, the color adjustment management apparatus:
performs at least two among in-plane unevenness adjustment, maximum density adjustment, single-color tone adjustment, mixed-color tone adjustment, generation of a color conversion table, and tone curve adjustment,
thereafter performs processing related to judgement on color matching, and
based on a result of the processing related to judgement on color matching, performs at least one among the in-plane unevenness adjustment, the maximum density adjustment, the single-color tone adjustment, the mixed-color tone adjustment, the generation of the color conversion table, and the tone curve adjustment.

11. The color adjustment management method according to claim 9, wherein in the second routine, the color adjustment management apparatus:
performs color verification, and
thereafter, based on a result of judgment on color matching in the color verification, performs at least one of in-plane unevenness adjustment, maximum density adjustment, single-color tone adjustment, mixed-color tone adjustment, generation of a color conversion table, and tone curve adjustment.

12. The color adjustment management method according to claim 9, wherein in the third routine, the color adjustment management apparatus:
performs adjustment of print sample scanning, and
based on a result of the adjustment of print sample scanning, performs at least either tone curve adjustment or adjustment of specified color conversion.

13. The color adjustment management method according to claim 9, wherein in the fourth routine, the color adjustment management apparatus performs at least two among spot color adjustment by colorimetry, spot color adjustment based on comparison of candidate colors, and spot color adjustment by manual input.

14. A color adjustment management apparatus comprising a hardware processor that performs the color adjustment management method according to claim 1.

15. A non-transitory computer-readable storage medium storing a program for causing a computer that controls a color adjustment management apparatus to execute the color adjustment management method according to claim 1.
